(19) United States
(12) Patent Application Publication
(10) Pub. No.: US 2010/0323047 A1
(43) Pub. Date: Dec. 23, 2010

(54) Solid one-piece cutter hub and blade combination

(76) Inventor: Michael A. Fridley, Troutville, VA (US)

Correspondence Address: JACOBSON HOLMAN PLLC, 400 SEVENTH STREET N.W., SUITE 600, WASHINGTON, DC, 20004, US

(21) Appl. No.: 12/801,639

(22) Filed: Jun. 17, 2010

Related U.S. Application Data
(60) Provisional application No. 61/213,531, filed on Jun. 17, 2009.

(51) Int. Cl. B29C 47/08; B29B 9/06; B26D 7/26

(52) U.S. Cl. 425/67; 83/675; 83/698.41

(57) ABSTRACT

A cutter hub for an underfluid pelletizer in which pelletizable material such as molten polymer is extruded as strands through orifices in a die plate. The cutter hub has a plurality of cutter blades integral therewith and is made of a single solid one-piece construction of hub and blades. The cutter hub is rotatably driven and moves along the face of the die plate so that the blades cut the extruded strands into pellets. The cutter hub preferably includes self-aligning structure.

This is a complete application claiming benefit of provisional 61/213,531, filed Jun. 17, 2009.

### BACKGROUND OF THE INVENTION

1. Field of the Invention

The present invention relates to cutter hub and blade assemblies for pelletization processes in which pellets are extruded through a die plate and blades on a rotating cutter hub which moves along the surface of the die plate to sever the pellets. The improvements represented by this invention involve a solid one-piece design of the cutter hub and blades, in which the blades are not fixedly attached to the cutter hub, but instead are an integral part of a solid one-piece cutter hub and blade combination.

2. Description of the Prior Art

The generally independent processes of, and equipment for use in, extrusion, pelletization, drying, and bagging of polymeric and similar materials are known and have been used in various applications. Underwater pelletizers for forming plastic pellets, and pellets of other extrudable material, by the use of an extrusion die having orifices through which molten polymer, or other material, is extruded out from a die face for engagement by cutter blades mounted on a rotatable cutter hub and driven by a drive shaft are well known. One of the characteristics of underwater pelletizers is the desirability of maintaining the cutter blades and die face in properly aligned relation in order that the cutting edge of the blades on the rotating cutter hub move in very close parallel relation to the die face. This close parallel relationship allows the blades to efficiently cut the extruded plastic into pellets as the plastic strands are discharged from the orifices in the extrusion die plate and prevents unnecessary wear of the cutter blades and/or die plate face.

U.S. Pat. No. 5,624,688 (“the '688 patent”), which is owned by the assignee of the present invention, discloses a self-aligning cutter hub assembly which connects the cutter hub to the pelletizer drive shaft. The assembly transmits torque from the drive shaft to the cutter hub while at the same time allowing limited universal movement of the cutter hub in relation to the rotational axis of the drive shaft. This universal movement enables the cutter blades on the cutter hub to maintain optimum parallel relation to the die face of the extrusion die plate to efficiently cut the extruded plastic material into pellets. The structure connecting the cutter hub to the drive shaft also enables effective assembly and disassembly of the components of the cutter hub onto and off of the end of the drive shaft. The disclosure of the '688 patent is expressly incorporated herein by reference as if fully set forth.

The cutter hub of the '688 patent includes a central bore defining an inner surface and an adapter received in the bore and fixedly attached to the end of the drive shaft. The inner surface of the hub bore and the outer surface of the drive shaft adapter are provided with corresponding partial spherical surfaces which coact to enable the requisite universal movement of the cutter hub in relation to the drive shaft. The drive shaft adapter is mounted on the end of the drive shaft, as by screw threads or the like, and the adapter and hub bore each include diametrically arranged recesses for partially receiving spherical balls which transmit the driving torque from the drive shaft to the cutter hub.

The recesses on the inner surface of the cutter hub bore are preferably diametrically opposed axial recesses or grooves which extend inwardly from one end surface of the cutter hub but do not extend completely to the other end surface of the cutter hub. The inner surface of the cutter hub bore also includes a short circumferential recess extending from each edge of the axial recess or groove and opening to the end surface of the cutter hub open to the axial recess. The recesses enable the adapter and torque transmitting balls to be assembled into the bore of the cutter hub when the adapter is oriented in perpendicular relation to the surface of the cutter hub. The drive shaft adapter can then be rotated 90° to register the partially spherical inner surface in the bore of the cutter hub with the partial spherical outer surface of the adapter.

The recesses or grooves in the inner surface of the cutter hub bore receive the torque transmitting balls during assembly of the drive shaft adapter with pivoting of the adapter into final position locking the torque transmitting balls in position. The adapter can then be assembled onto the drive shaft, such as by a screw threaded engagement between the drive shaft and adapter or other engagement assembly.

U.S. Pat. No. 6,793,473 (“the '473 patent”), also owned by the assignee of the present invention, discloses a modification of the self-aligning cutter hub assembly of the '688 patent. More specifically, the '473 patent provides an assembly retainer for the cutter hub which places an obstruction in the open end area of the axial recesses. This obstruction prevents the torque transmitting balls from moving out of the axial recesses thereby maintaining the hub, drive shaft adapter and balls in assembled relation when the self-aligning cutter hub is not assembled on the drive shaft such as when components of the cutter hub are being replaced, adjusted, and the like. The disclosure of the '473 patent is also expressly incorporated herein by reference as if fully set forth.

U.S. Pat. No. 4,251,198 (“the '198 patent”), also owned by the assignee of the present invention, discloses a cutter hub for use in an underwater pelletizer, in which replaceable, double or single edged blades are attached to each arm of the hub with a major portion of the length of the blade being attached to and supported by the arm on the hub. This arrangement results in less axial deflection with increased cutting pressure, since the rigid hub arm carries the rotational stress without deflection of the blade cutting surface. Further, this arrangement produces higher quality pellets, requires fewer knife adjustments, reduces the radial wear pattern on the pellet die plate, permits the use of thinner, less costly blades and permits the use of single edged blades or double-edged blades with a useable second edge. The disclosure of the '198 patent is also expressly incorporated herein by reference as if fully set forth.

Additional U.S. patents, also owned by the assignee of the present invention, relating to underwater pelletizers, cutter hub assemblies, structures for positioning the cutter hub and cutter blades in desired relation to the die face of the die plate, die equipment and designs for underwater pelletizers, and dryers used in conjunction with underwater pelletizers, include the following Nos.

| | | |
|---|---|---|
| 3,458,045 | 5,059,103 | 6,807,748 |
| 4,123,207 | 5,265,347 | 6,824,371 |
| 4,218,323 | 5,403,176 | 7,024,794 |
| 4,251,198 | 5,624,688 | 7,033,152 |
| 4,447,325 | 5,638,606 | 7,171,762 |
| 4,500,271 | 6,138,375 | 7,267,540 |
| 4,565,015 | 6,237,244 | 7,318,719 |
| 4,621,996 | 6,332,765 | 7,402,034 |
| 4,728,276 | 6,739,457 | 7,421,802 |
| 4,896,435 | 6,793,473 | |

While the Assignee of the present invention and its engineers and personnel have been in the business of manufacturing and selling underwater pelletizing equipment utilizing rotating cutter hubs with attached cutting blades for over 40 years, as evidenced by the aforesaid U.S. patents, no one has designed and developed a solid one-piece cutter hub and blade combination until the present invention.

### SUMMARY OF INVENTION

The present invention is directed to a solid one-piece cutter hub containing a multiplicity of cutter blades integral therewith, wherein the cutter hub and the cutter blades are of a solid one-piece construction. In other words, the cutter hub and cutter blades are machined out of one solid piece of material, such as a metallic material. The solid one-piece cutter hub and blade combination of the present invention also has a streamlined design to provide a dynamically-enhanced surface for smooth fluid flow over the cutter hub and blade surfaces. This one-piece cutter hub and blade combination can be used in many different type pelletizing applications, including underwater pelletizing and hot-face pelletizing, thus the term “underfluid pelletizing”.

As used herein, the term “underfluid pelletization” can utilize liquids to pelletize and transport the cut material, as well as gases, so as to include hot-face cutting. The transport liquid can be any liquid and is preferably water. Other liquids include alcohol, water-alcohol mixtures, mineral oil, vegetable oil, etc. Optionally, the water or other transport liquid can contain additives including, but not limited to, flow modifiers, coatings, defoamers, co-solvents, and the like. As used herein, when references are made to “water” in connection with the transport liquid, such references are intended to refer to any liquid suitable for use as a transport liquid, with or without additives, and not just water.

When used in conjunction with the present invention, the term “cutter hub” is intended to include the rotating cutter hub with integral cutting blades as a solid one-piece cutter hub and cutter blade combination, and the term “cutter blades” is intended to mean the cutting edges of the cutting blades of the one-piece combination.

In underwater pelletizing, the one-piece cutter hub of the present invention provides a hydrodynamically-enhanced surface for the water or other liquid flow through the cutting chamber or waterbox. In hot-face pelletizing, the one-piece cutter hub and blade combination provides an aerodynamically-enhanced surface for the air or other gas through which the assembly rotates. Hence, in the broad context, the one-piece cutter hub of the present invention can be used in underfluid pelletization. However, the specific embodiments described and illustrated herein are directed to underwater pelletizers, which are the preferred application for the solid one-piece cutter hub of the present invention. Further, the solid one-piece cutter hub of the present invention preferably includes self-aligning structure and operation, such as disclosed in the '688 and '473 patents.

Another characteristic of underfluid pelletizers is the desirability to utilize cutter hubs capable of containing many cutter blades. In many applications cutter hubs with 10 or more cutter blades is preferred. This number of cutter blades on prior art cutter blades creates several problems. In some instances the number of desired cutter blades cannot be placed on the cutter hubs due to space requirements, because of machining interferences or mounting arms of the hubs and/or assembly of the fasteners and their tools. Due to the elimination of the separate blades, and the attendant threaded bolts or other elements for attaching the blades to the cutter hub, the solid one-piece cutter hub of the present invention can provide a significantly greater number of cutting blade edge surfaces than heretofore possible with prior art cutter hub and separate blade assemblies for the same size cutter hub. Typically, prior art cutter hubs mount six or eight blades. In contrast, the solid one-piece cutter hub of the present invention can include as many as 12 or 14 cutting edges, thus providing significantly more cut pellets per revolution of the cutter hub.

The solid one-piece cutter hub of the present invention can be used to pelletize a variety of extrudable materials, providing a range of benefits in various underfluid pelletization applications, including more efficient pelletizing operations.

In the underfluid pelletizing of extruded materials it has always been desirable to minimize the amount of electrical amps used by the pelletizer motor, as is desirable in many other industries. As discussed above, existing cutter hub designs use detachable cutter blades which are two sided, that are of sufficient length to increase the electrical motor amps required to desirably pelletize certain materials, as compared to the cutter hub of the present invention. Such designs while effective and efficient for some materials are not necessary for processes in which the processing material's wear on the cutter blades is minimal and/or the desired rate and pellet size requires a cutter hub with many blades, for example, those with 20%-50% more blades than those on traditional cutter hubs due to conventional blade mounting or methods/mechanisms. In such circumstances, the material may never be efficiently pelletized because excess electricity would be used and/or because prior art designs may not be capable of incorporating the amount of cutting blade edges needed for efficient pelletizing.

A system for underfluid pelletization can include a melting and/or mixing section(s), pump(s), cooling and/or diverting section(s), pelletizer(s), drying section(s), and/or a post processing section(s). The system can further include a controller, such as a programmable logic controller (PLC), to control one or more process conditions relating to the operation of the above mentioned sections.

When the cutter blades start to wear and/or dull over time due to the constant interaction with the process material and contact against the die face, to name a few, the blades need to be replaced to maintain pelletizing efficiency. However, pelletizing efficiency is lost due to the increased time it takes to replace the large number of blades when they become worn and/or dull. The cutter hubs of the prior art utilize cutter blades that are detachably connected to the arms of the cutter hubs by way of screws and bolts, and other means known to those skilled in the art. In applications calling for a high number of cutter blades ones' ability to detach and reattach cutter blades is limited due to the limited space in which to work, in part due to the high number of blades. In contrast, the solid one-piece cutter hub of the present invention can simply be unscrewed and replaced by a new cutter hub when the cutter blades become sufficiently worn or dull which creates efficiencies in the change-over process by eliminating the tedious and potentially dangerous task of changing individual cutter blades. The danger mentioned is to maintenance staff that could cut fingers or hands while using tools to loosen and remove screws from the blades, or during the installation of new blades which requires the loosening and retightening of screws and blades.

Additionally it is desirable for cutter hubs to be as streamlined as possible to enhance pelletizing efficiently. In underfluid pelletization the cutter hub turns inside what is commonly referred to as a “cutting chamber” or “waterbox”, which is filled with a flowing transportation fluid, such as water. When the pelletizer is in operation and the cutter hub is turning in the transportation fluid more amps are needed than if the cutter hub was spinning in air for example. Resistance is created by the cutter hub turning in transport fluid, such as water, and the design of the cutter hub with multiple arms and long two-sided cutter blades. What is needed then is a dynamically-enhanced cutter design which creates less resistance, thus requiring fewer amps to be used by the pelletizing motor during pelletizing operations such as cutter hubs that can rotate at high speeds, 3500 rpm for example, yet requiring less electricity than conventional cutter hub and blade assemblies. Another benefit derived from a dynamically-enhanced cutter hub is a reduction of cavitation which has been found by many in the art to be detrimental in many applications, especially underwater applications.

Accordingly, one aspect of the present invention includes providing a solid-one piece cutter hub that minimizes the electrical amps needed to pelletize certain materials at certain rates by streamlining its design. As used herein, the terms “streamlining”, “streamlined” and “dynamically-enhanced” refer to the efficiency at which a cutter hub, and specifically to the instant invention, the solid one-piece cutter hub, can operate by rotating in a waterbox.

Another aspect of the present invention includes providing a solid one-piece cutter hub with a self aligning center that allows for easy self alignment of the cutter blades to the face of the die plate and/or orifices of the die plate so as to facilitate efficient pelletization. Poor or improper cutter-to-die alignment can cause the pellets to have improper cuts and can result in the pellets having tails or worse the pellets can remain not completely cut or sheared in two, thus producing chains of pellets stuck together, or worse the pellets can get caught onto the blades thus creating clumps of pellets or agglomerations or worse complete wrapping of the polymer strand(s) around the cutter hub so much as to block the cutting chamber/waterbox and/or piping from the waterbox.

Another aspect of the present invention includes providing a more efficient pelletization process in which cavitation in the waterbox is reduced with the use of the instant invention's new streamlined design. Cavitation is a result of the combination of many blades such as up to 3 or more rotating at high speeds, such as up to 2000 rpm or more, against the die face surface in such a way that the liquid flow into the cutting chamber cannot fully flow around each blade and/or the center area of the cutter space such that a vacuum void begins and exists. As more blades and/or high cutter speeds are employed, the vacuum void grows in volume to the point it negatively affects the cutting of material.

Yet another aspect of the present invention is to provide a solid-one piece cutter hub which is resistant to corrosion, abrasion, and wear due to the use of coatings/surface treatments.

Additionally, the elimination of pellet hang-up points is another aim of the present invention. The set screws which are used in prior art designs hold the detachable blades in place and consequently serve as hang up points for newly cut pellets, thus creating undesirable chains and strings of pellets. With no need for set screws in the design of the present invention these hang-up points are eliminated.

Yet another characteristic of the present invention is to provide a cutter hub design in which the “tracking” of the cutter blades against the die face remains the same or approximately the same during the cutter blade life, from the beginning of use until the blades have been sufficiently worn. The cutter hub of the present invention allows the face of the cutter blades to wear evenly throughout the blades' entire life.

Still yet another aspect of the present invention is to reduce and/or eliminate the unwanted and accidental movement of the cutter blades during the pelletization process. It is known that cutter hubs using replaceable blades which are held in place by screws can prematurely move, such as when the screws are accidentally left untightened, not tightened enough, or if they become loose under stress loads from the high speed rotation and impacts associated with the normal and/or any abnormal run conditions associated with the pelletizing process.

And still yet another aspect of the present invention is to provide a cutter hub with the ability to hold a larger amount of blades in relation to its size than prior art cutter hubs, which in turn allows for many benefits such as increase cutting rate without increasing rotating rate and/or the ability to make smaller pellets.

Continuing, an additional aspect of the present invention is better tracking of the cutter blade surfaces against the face of the die plate. Prior art designs can cause the tracking of the cutter blades to “walk” when they are worn down over time. The “walking” of blades associated with the wearing of the blades is now eliminated with the present invention due to the blades being curved inwardly. The one piece design of the cutter hub allows the blades to be curved and to retain constant tracking against the die face throughout the lifetime of the blades.

Over time, the demand for processes and equipment capable of efficiently pelletizing and drying extrudable materials has increased. Yet, the prior art is silent as to the use of solid one-piece cutter hub. What is needed then is a cutter hub design which addresses all of the before mentioned issues.

### BRIEF DESCRIPTION OF THE DRAWINGS

FIG. 1 is a sectional view of an underwater pelletizer illustrating a self-aligning cutter hub associated with other components, similar to FIG. 1 of the '688 patent.

FIG. 2 is an end elevational view of a prior art cutter hub assembly, without cutter blades, similar to FIG. 2 of the '688 patent.

FIG. 3 is a sectional view, on an enlarged scale, taken along section line 3-3 on FIG. 2, illustrating the matching relationship between the exterior of the adapter and the interior of the cutter hub bore, similar to FIG. 3 of the '688 patent.

FIG. 4 is a sectional view, on an enlarged scale, taken along section line 4-4 on FIG. 2, illustrating the relationship between the exterior of the adapter, the interior of the cutter hub bore, and the torque transmitting balls, similar to FIG. 4 of the '688 patent.

FIG. 5 is a perspective rear side view of one embodiment of a solid one-piece cutter hub in accordance with the present invention.

FIG. 6 is a side view of the solid one-piece cutter hub of FIG. 5.

FIG. 7 is a perspective rear side view of another embodiment of a solid one-piece cutter hub in accordance with the present invention, included with a self-aligning adapter insert centrally positioned within the cutter hub bore.

FIG. 8 is a top plan view of the rear side of the cutter hub of FIG. 7.

FIG. 9 is a cross-section view taken along section line 9-9 of FIG. 7.

FIG. 10 is an exploded perspective view of the cutter hub of FIG. 7 with the self-aligning adapter insert removed from the center of the cutter hub.

FIG. 11 is a top plan view of the rear side of the cutter hub of FIG. 7, similar to FIG. 8, showing an angle of cut of approximately 30°.

FIG. 12 is a side view of the cutter hub of FIG. 7, similar to FIG. 6, showing a blade slant angle of 45°.

### DETAILED DESCRIPTION OF THE INVENTION

Referring now to the drawing figures, wherein like reference numerals represent like parts throughout the several views, exemplary embodiments of the present invention will be described in detail. Throughout this description, various components may be identified having specific values or parameters, however, these items are provided as exemplary embodiments. Indeed, the exemplary embodiments do not limit the various aspects and concepts of the present invention as many comparable parameters, sizes, ranges, and/or values may be implemented. The terms “first,” “second,” and the like, “primary,” “secondary,” and the like, do not denote any order, quantity, or importance, but rather are used to distinguish one element from another. Further, the terms “a”, “an”, and “the” do not denote a limitation of quantity, but rather denote the presence of “at least one” of the referenced item.

Although only two preferred embodiments of the invention are explained in detail, it is to be understood that the embodiments are given by way of illustration only. It is not intended that the invention be limited in its scope to the details of construction and arrangement of components set forth in the following description or illustrated in the drawings.

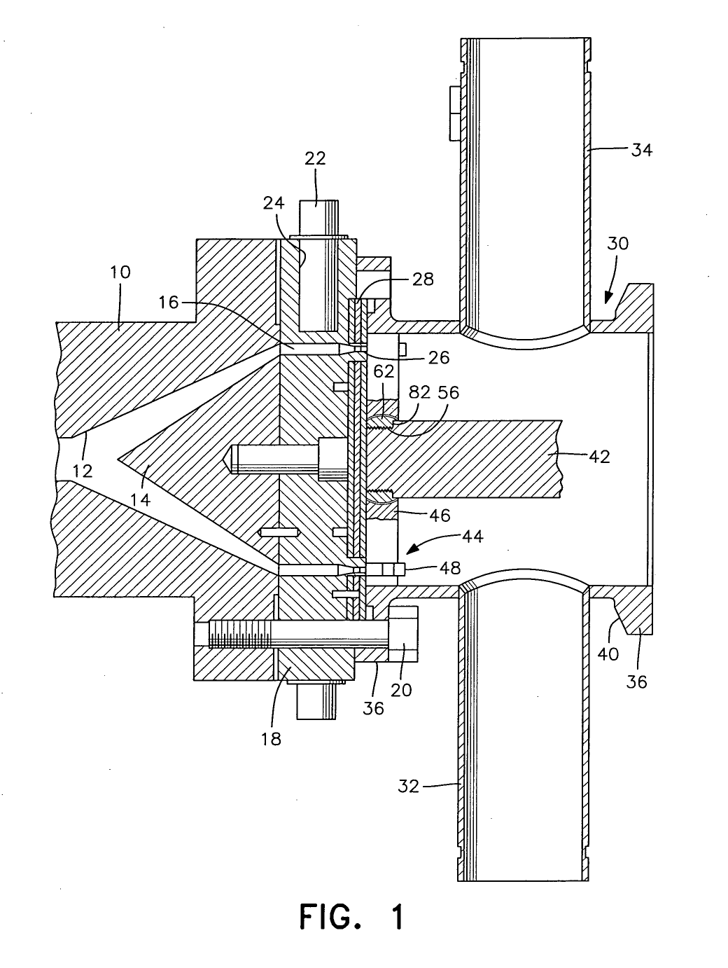

Referring now to FIGS. 1-4 of the drawings, there is shown an underwater pelletizer structure with a self-aligning cutter hub as shown in the '688 patent. The pelletizer includes an inlet housing 10 having an inlet passageway 12 for receiving the material to be pelletized, such as molten polymer, from upstream equipment. The molten polymer is diverted outwardly by a nose cone 14 and enters into a plurality of extrusion orifices 16 in a die plate 18. The die plate 18 is secured to the inlet housing by fastening bolts 20 or the like and typically is provided with heating elements 22 located in cavities 24 in the die plate. The die plate includes a die face 26 of wear resistant material which is mounted on the die plate along with heat insulation plates 28.

Attached to the housing 10 and die plate 18 is a cutting chamber generally designated by reference numeral 30, which includes a circulating transport fluid inlet passageway 32 and a discharge passageway 34 for the transport fluid, such as water, and entrained pellets. The housing 35 for the cutting chamber 30 includes a flange 36 for attaching to the die plate and a flange at opposite end thereof having an inclined surface 40 for association with a similar flange on an adapter connected to a drive unit, such as a drive motor or the like (not shown). A drive shaft 42 extends through the cutter chamber 30 and supports and drives a cutter assembly generally designated by reference numeral 44. The cutter assembly 44 includes a cutter hub 46 and a plurality of cutting blades or knives 48 having their cutting edges associated with the die face 26 and the discharge point of the orifices 16. The cutter hub includes two end surfaces, one end surface 49 faces away from the die plate toward the drive motor (not shown), i.e., the rear side. The side facing the die face is the front side.

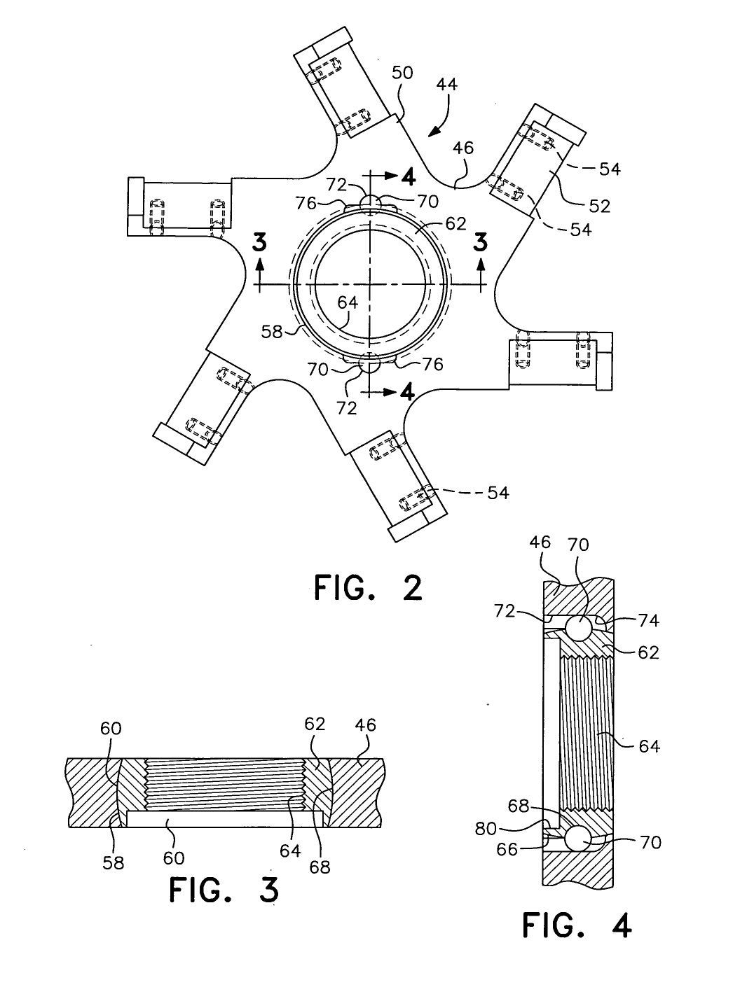

The prior art cutter hub 46 of the '688 patent includes a plurality of radial arms 50 (see FIG. 2), each having notches 52 which receive the cutter blades that are secured by the use of conventional fasteners threaded into bores 54, as is well known in the art. The arms 50 are integral with the central portion 51 of hub 46.

Cutter hub 46 is also provided with an axial bore 58 which extends therethrough and which has an inner face that is partially spherical as indicated by reference numeral 60 in FIG. 3. Positioned in the bore 58 is a drive shaft adapter 62 having an internally threaded bore 64 extending therethrough. The threaded bore 64 allows the adapter 62 to be screw threadedly connected onto a reduced externally threaded end portion 56 of the drive shaft 42 to form a rigid unit as shown in FIG. 1. The exterior surface of the adapter 62 is also partially spherical as indicated by reference numeral 66 in FIG. 3. The curvature of the partially spherical surfaces 60 and 66 are matching or corresponding and closely associated as illustrated in FIG. 3. As such, the diameter of the partially spherical surfaces at the end edges thereof are less than the diameter at the central portions.

The partially spherical exterior surface 66 of the adapter is provided with a pair of diametrically opposed generally semispherical recesses 68 oriented equally distant from the end edges of the partially spherical surface 66 as illustrated in FIG. 3. Received in each of the semispherical recesses 68 is a spherical ball 70.

The hub bore 58 includes a pair of diametrically opposed axial, semi-cylindrical recesses 72 which extend inwardly from end surface 49 of the hub bore. The recesses 72 terminate at their inner ends in a partially spherical inner end 74 which is adjacent but spaced from the opposite end surface 47 of the bore 58. The recesses 72 receive the balls 70 which provide the torque transfer from the shaft 42 and adapter 62 to the hub 46.

In order to assemble the adapter 62 and balls 70 with respect to the bore 58, the bore 58 includes an axial recess 76, see FIG. 2, in end or rear surface 49 which extends circumferentially a short distance from the edges of the recess and terminates with an inner end spaced from the spherical portion 74 of the recess 72. The recesses 76 are provided to enable the partially spherical surface 66 of the adapter 62 to be inserted into the bore 58 when the adapter 62 is oriented in substantially perpendicular relation to the bore. The balls 70 are placed and retained in the cavities 68 in a suitable manner, such as by the application of grease or the like. With the adapter 62 in substantially perpendicular relation to the hub 46, the balls 70 can be received in the recesses 72 when the assembled adapter 62 is moved into the bore 58. The bore 58 does not block the larger diameter central portion of the surface 66 of the adapter 62 because of the recesses 76 in end surface 49. When the balls 70 reach a central point between the two ends of the bore 58, the adapter 62 can be rotated 90 degrees into the bore 58 with the partially spherical surfaces 60 and 66 being in close registry as illustrated in FIG. 3. The curvature of the surfaces 60 and 66 then serves to retain the adapter 62 within the bore 58 and retain the balls 70 in the recesses 68 and 72.

The balls 70 transmit driving torque and the surfaces 60 and enable the hub 46 to pivot universally in relation to the drive shaft. This universal movement enables the cutter hub 46 and cutting blades or knives 48 to remain oriented in parallel closely spaced relation to the die face 26 for efficiently cutting the extruded material such as polymer into pellets regardless of angular variation in the drive shaft 42.

After the adapter 62 has been assembled into the cutter hub 46 to the position illustrated in FIG. 3, the cutter hub and the adapter are mounted on the drive shaft 42 by engaging the internal threads 64 of the adapter 62 with the external threads 56 of the drive shaft 42 until the axial recess 80 formed in one end of the shaft. As assembled, the outer spherical surface 66 of the adapter, and the matching inner spherical surface 60 of the hub bore 58, are oriented slightly outwardly of the periphery of the drive shaft in view of the distance between the periphery of the internal recess 80 and the periphery of the surfaces 66 and 60 radially outwardly thereof. This assembly enables the cutter hub to pivot universally on the end of the drive shaft 42 as defined by the adapter 62 which is rigidly secured thereon.

All of the above described structure and operational procedure for a self-aligning cutter hub, corresponding with that disclosed in the '688 patent, is known, but is included to illustrate the preferred method for self-alignment to be used with the solid one-piece cutter hub of the present invention. The foregoing description also illustrates the relationship of the solid one-piece cutter hub of the present invention in an underfluid pelletization process, such as underwater pelletizing. The cutter hub of the present invention is generally positioned within the cutting chamber 30 and is aligned with the die plate, as shown in FIG. 1. Optionally, the cutter hub of the present invention can contain no self-aligning feature. Additionally the solid one-piece cutter hub of the present invention can be assembled with other self-aligning structures, such as that disclosed in the '473 patent, in U.S. Pat. No. 6,663,372, shown in FIGS. 4 and 7, and U.S. application, Pub. No. U.S. 2003/0178231 A1.

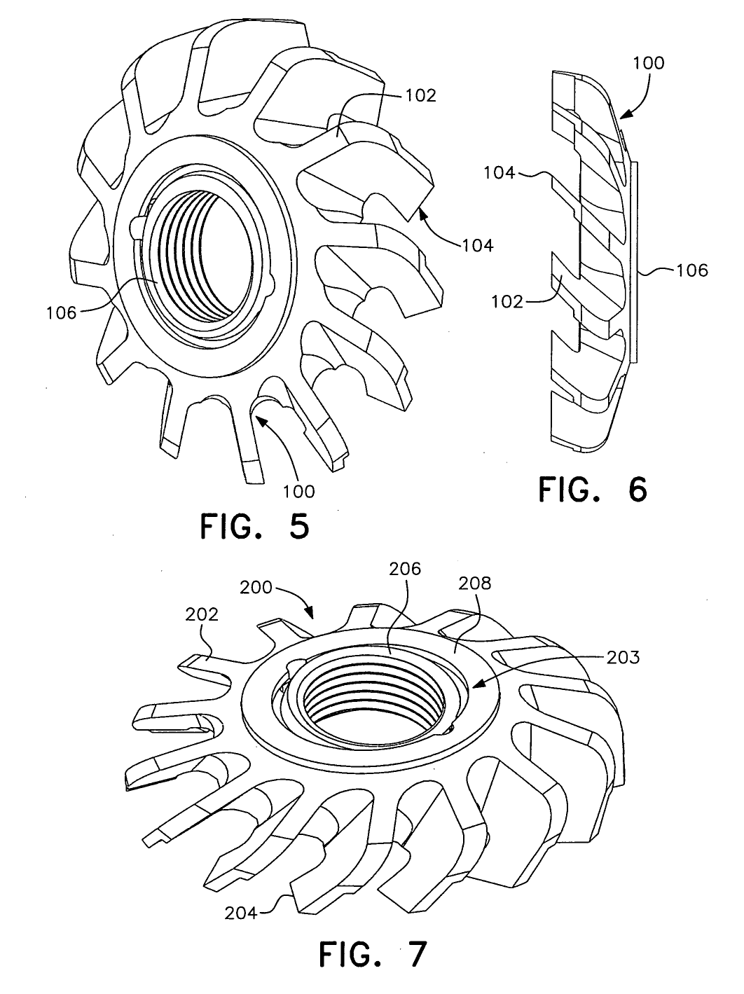

Turning now to FIGS. 5 and 6, there is shown one embodiment of a solid one-piece cutter hub in accordance with the present invention, generally designated by reference numeral 100, which includes a self-aligning adapter 106 as disclosed in the '688 patent. Specifically, the adapter 106 corresponds in structure to adapter 62 of the '688 patent and the bore of the one-piece cutter hub 100 is machined as disclosed in the '688 patent. Torque transmitting balls (not shown in FIGS. 5 and 6) transmit the torque between the adapter 106 and the cutter hub 100.

The cutter hub 100 includes at least one radial arm 102 and thus one cutting blade area 104, and may include a plurality of arms 102 and cutting blade areas 104. Preferably, the solid one-piece cutter hub of the present invention contains a plurality of arms 102 and cutter blade areas 104, with the exact number varying, depending on the applications and processes in which the present invention is being used. As shown, the cutter hub 100 includes 12 arms 102 and cutter blade areas 104.

Arms 102 and cutting blade areas 104 of cutter hub 100 in relation to a die face, i.e., the blade slant angle, can vary from 90° to about 10°, preferably from about 70° to about 30°, with 45° being the most preferred blade slant angle. Just as with the number of arms and cutting blade areas, the blade slant angle of arms 102 that may be used in accordance with the present invention will depend on the application and process in which the present invention is being used.

The solid one-piece cutter hub 100 is akin to cutter hub 46 illustrated in FIG. 2. The major difference between the two designs is that cutter hub 100 is machined out of a single piece of material, such as a metallic block, thus eliminating the need for separate detachable cutter blades, threaded bores for fastening the blades to the cutter hub, and fasteners. The design of the present invention allows the cutter hub 100 with arms 102 and cutting blade area 104 to be of a solid one-piece construction. The end of arms 102 are sharpened to create the cutting blade area 104 that will rotate across the face of a die plate and cut the extruded material.

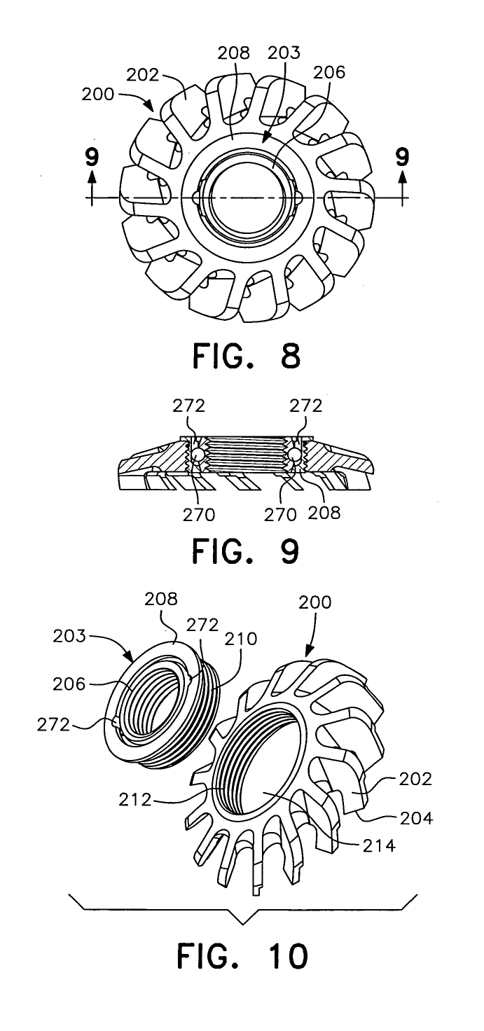

A second embodiment of a solid one-piece cutter hub in accordance with the present invention is illustrated in FIGS. 7-12. In the second embodiment, the solid one-piece cutter hub is generally designated by reference numeral 200 and includes 14 radial arms 202 integral therewith. The radial arms 202 define cutter blades with cutting blade areas 204 which cooperate with the die face to pelletize the material extruded through the die holes of the die plate as the solid one-piece cutter hub 200 rotates with respect thereto.

The cutter hub 200 also includes a self-aligning structure which is similar to that disclosed in the '688 patent, but slightly different. More specifically, the self-aligning structure is in the form of a self-contained insert, generally designated by reference numeral 203. The cylindrical insert 203 includes an insert body 208 having screw threads 210 on its outer circumference which mate with internal screw threads 212 formed in the bore 214 of the cutter hub 200 for threaded engagement therewith. See FIGS. 9 and 10. The diametrically opposed axial, semi-cylindrical recesses 272, for receiving the torque transferring balls 270, are thus formed in the inner wall of the insert body 208. An adapter 206 according to the '688 patent is then received within the insert body 208 which together define the mating partially spherical surfaces 260 and 266, which provide for the universal movement of the adapter 206.

When the self-aligning adapter is constructed in accordance with the embodiment shown in FIGS. 9 and 10, the adapter 206 and insert body 210 can remain threaded on the drive shaft, such as drive shaft 42 shown in FIG. 1, and the solid one-piece cutter hub 200 can be threadedly removed when replacement is desired. Alternately, the adapter 206 and insert body 210 can be replaced out at the same time as the cutter hub 200, if desired.

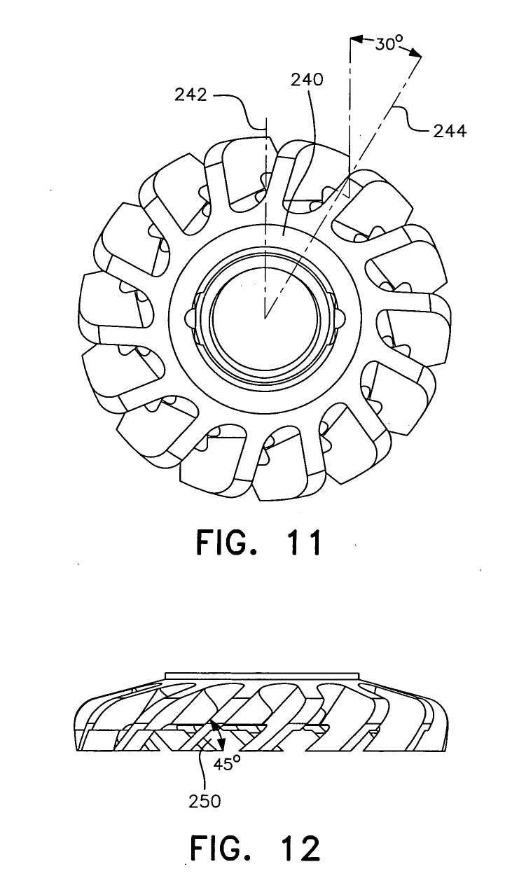

Next, turning to FIG. 11, it will be seen that the cutter blades 202 are angled slightly forwardly with respect to a radius line of the cutter hub 200, designated by reference numeral 242 in FIG. 11. This angle of cut, designated by reference numeral 244 in FIG. 11, can be varied depending upon the application and process in which the solid one-piece cutter hub is used, varying between about 0°, or straight cut with the cutter blades on radius, and about a 60° forward angle. The angle of cut is preferably about 30°, as shown in FIG. 11. FIG. 12 illustrates the preferred blade slant angle, designated by reference numeral 250, to be about 45°.

FIGS. 11 and 12 also show the inward curvature of the cutter blades 202 toward the center of the cutter hub 200. This inward curvature, or toe-in, formed in the blades 202 allows the blades to retain constant tracking as the blades wear down in use and mitigates the walking of blades associated with prior art cutter hub and blade assemblies.

The foregoing descriptions and drawings should be considered as illustrative only of the principles of the invention. The invention may be configured in a variety of shapes and sizes and is not limited to the dimensions of the preferred embodiments. Numerous applications of the present invention will readily occur to those skilled in the art. Therefore, it is not desired to limit the invention to the specific embodiments disclosed or the exact construction and operation shown and described. Rather, all suitable modifications and equivalents may be resorted to, falling within the scope of the invention.

What is claimed is:

1. An underfluid pelletizer comprising:
a driven rotating shaft;
a die plate with a die face and die holes for extruding an extrudable material as strands away from said die face; and
a solid one-piece cutter hub having a plurality of cutter blades integral therewith for rotation with said rotating shaft and cooperating with said die face to cut said strands with said cutter blades into pellets.

2. The pelletizer as set forth in claim 1, wherein said pelletizer is an underwater pelletizer or a hot-face pelletizer.

3. The pelletizer as set forth in claim 1, wherein said solid one-piece cutter hub includes a self-aligning mechanism.

4. The pelletizer as set forth in claim 1, wherein said solid one-piece cutter hub includes radially extending arms and said cutter blades are integral with respective ends of said arms facing the die face.

5. The pelletizer as set forth in claim 1, wherein the cutter blades of the solid one-piece cutter hub are at an angle of between about 0° and about a 60° forward angle with respect to a radius line of said cutter hub.

6. The pelletizer as set forth in claim 1, wherein a blade slant angle of the cutter blades with respect to the die face is between about 90° and about 10°.

7. The pelletizer as set forth in claim 3, wherein said cutter hub includes a central portion and a plurality of radial arms extending outwardly from said central portion and integrally formed therewith.

8. The pelletizer as set forth in claim 7, wherein said central portion has a central hub bore formed therein and a plurality of internal threads in said bore, said self-aligning mechanism being received within said hub bore.

9. The pelletizer as set forth in claim 8, wherein said self-aligning mechanism includes an insert body having a partially spherical inner wall and an adapter having a partially spherical outer surface for complementary engagement with said insert body inner wall to provide universal movement of said adapter within said insert body, said insert body having a plurality of external threads which mate with said hub bore internal threads to secure said self-aligning mechanism within said bore.

10. The pelletizer as set forth in claim 9, wherein said insert body inner wall includes diametrically opposed axial, semi-cylindrical recesses that extend inwardly from an end surface of the hub bore for receiving torque transferring balls for transferring torque from the rotating shaft to the hub.

11. A solid one-piece cutter hub and cutter blade assembly for an underfluid pelletizer comprising a cutter hub integrally formed with a plurality of cutter blades as a single piece.

12. The solid one-piece cutter hub and cutter blade assembly as set forth in claim 11, wherein said cutter hub includes a central portion and a plurality of radial arms extending outwardly from said central portion and integrally formed therewith.

13. The solid one-piece cutter hub and cutter blade assembly as set forth in claim 12, wherein said cutter blades are integral with outer ends of said arms.

14. The solid one-piece cutter hub and cutter blade assembly as set forth in claim 12, wherein said central portion has a central hub bore formed therein and a plurality of internal threads in said bore, and further comprising a self-aligning mechanism received within said hub bore, said self-aligning mechanism including an insert body having a partially spherical inner wall and an adapter having a partially spherical outer surface for complementary engagement with said insert body inner wall to provide universal movement of said adapter within said insert body, said insert body having a plurality of external threads which mate with said hub bore internal threads to secure said self-aligning mechanism within said bore.

15. The solid one-piece cutter hub and cutter blade assembly as set forth in claim 12, wherein the cutter blades are integral with outer ends of said arms and have a cutting surface that is adjacent and generally parallel with an underfluid pelletizer die face in use, said radial arms being slanted at an angle of between about 90° and about 10° with respect to the cutting surface.

16. The solid one-piece cutter hub and cutter blade assembly as set forth in claim 15, wherein said angle is between about 70° and about 30°.

17. The solid one-piece cutter hub and cutter blade assembly as set forth in claim 15, wherein said angle is about 45°.

18. The solid one-piece cutter hub and cutter blade assembly as set forth in claim 12, wherein the cutter blades are at an angle of between about 0° and about a 60° forward angle with respect to a radius line of said cutter hub.

19. The solid one-piece cutter hub and cutter blade assembly as set forth in claim 18, wherein said forward angle is about 30°.
